(19) United States
(12) Patent Application Publication
(10) Pub. No.: US 2011/0189885 A1
(43) Pub. Date: Aug. 4, 2011

(54) CONNECTOR ASSEMBLY HAVING A SOCKET WITH A TRANSFORMER AND A PLUG WITH A SWITCH WITH A MAGNET

(75) Inventor: Wen Chin TSAI, Taipei County (TW)

(73) Assignee: TOPS ELECTRONICS CO., LTD., Chung Ho City (TW)

(21) Appl. No.: 12/953,566

(22) Filed: Nov. 24, 2010

(30) Foreign Application Priority Data
Feb. 2, 2010 (TW) 099202161

(51) Int. Cl. H01R 13/70; H01R 3/00

(52) U.S. Cl. 439/488; 439/620.21

(57) ABSTRACT

A connector assembly includes a socket connector with a transformer circuit and a plug connector that is releasably fit to the socket connector. The plug connector includes a slidable power switch containing a magnet and a magnetic detection element that detects the magnetic field of the magnet. When the slidable power switch changes position to bring the magnet close to the magnetic detection element, a closed circuit is formed and a power supply is activated. When the magnet is moved away from the magnetic detection element, the circuit is open and the power supply is cut off. The plug connector has a front end with a rotatable water-tight collar. The socket connector includes a closure cap arranged at an end for temporarily engaging an external thread of the socket connector in order to protect the assembly when the socket connector is engaged with the plug connector.

### BACKGROUND OF THE INVENTION

1. Field of the Invention

The present invention is related to a connector assembly, and more particular to a water-proof power connector that comprises a power switch and features voltage transformation.

2. Description of Related Art

To charge an electronic product or to acquire electrical power for the electronic product, a power plug is directly plugged into a socket to establish conduction of electrical power. To cut off the power supply, the plug is unplugged. Frequent unplugging and re-plugging is certainly troublesome for general use. Thus, it is desired to have a measure to control the establishment and breaking of conduction of electrical power without unplugging of a plug in order to facilitate the use and operation thereof. Further, a conventional charging plug that is provided for outdoor use is susceptible to invasion of humidity if water-tightness is not properly formed. This makes cause potential risk of unsafe use of electrical power as well as damage of the plug.

Thus, the present invention aims to provide a connector assembly that overcomes the above discussed problems and drawbacks.

### SUMMARY OF THE INVENTION

Accordingly, the primary objective of the present invention is to provide a connector assembly, which comprises a slidable power switch that is movably mounted to a plug connector of the connector assembly, whereby a user may control the establishment or breaking of conduction of electrical power through a transmission cable by using the slidable power switch, without unplugging of the plug connector.

Another objective of the present invention is to provide a connector assembly, which comprises a plug connector that carries a water-tight collar, whereby when the plug connector is fit to a socket connector, the water-tight collar threadingly engages the socket connector to realize water-tight engagement therebetween.

A further objective of the present invention is to provide a connector assembly, which comprises a socket connector that receives a transformer circuit mounted therein to carry out transformation of voltage, whereby a mateable plug connector of the connector assembly does not need to contain a transformer.

Yet a further objective of the present invention is to provide a connector assembly, which comprises a plug connector that carries an ON/OFF indicator to indicate the ON/OFF state of electrical power through the plug connector and a socket connector that carries a power indicator to indicate the plugging of the plug connector to the socket connector.

A further objective of the present invention is to provide a connector assembly, which comprises a socket connector having an end carrying a closure cap, whereby when the socket connector is not in engagement with a plug connector, the closure cap temporarily engage an external thread of the socket connector for closure in order to realize protection and water resistance and wherein the socket connector has an internal void space for receiving a circuit and the void space is filled with an insulation silicone rubber to ensure humidity resistance and elimination of undesired circuit shorting.

In order to achieve the foregoing objectives, the present invention provides a connector assembly, which comprises the follow constituent components:

A socket connector comprises a socket, a closure cap, and a transmission cable. The socket connector comprises a transformer circuit arranged therein and a power indicator. The closure cap is arranged at an end of the plug connector.

A plug connector is mateable with the socket connector. The plug connector comprises a plug and a transmission cable. The plug connector comprises a slidable power switch. The slidable power switch comprises a magnet having a magnetic field detectable by a magnetic detection element mounted in the plug.

Thus, when the slidable power switch changes position to bring the magnet close to the magnetic detection element, the magnetic detection element detects change of the magnetic field of the magnet and initiates an activation signal that activate power supply to form a closed circuit. When the magnet is moved away, the magnet is distant from the magnetic detection element and the magnetic detection element generates a signal to open the circuit thereby cutting off power supply from the socket connector.

The plug connector has a front end carrying a rotatable water-tight collar, which has an inside surface forming an internal thread. The socket connector has an outside surface forming an external thread. The water-tight collar can be operated by rotation to threadingly engage the external thread of the socket connector so as to realize water-tight engagement for being used outdoors or in a water-proof application.

The socket connector carries the closure cap on an end thereof. The closure cap forms therein an internal thread, which is matingly engageable with an external thread formed on the end of the socket connector temporarily in case that the socket connector and the plug connector are not in threadingly engagement with each other yet. The socket connector has an internal void space for receiving the circuit. An insulation substance, such as insulation silicone rubber, is filled in the void space inside the socket connector to ensure humidity resistance and improve security of power transmission of the connector assembly.

### BRIEF DESCRIPTION OF THE DRAWINGS

The present invention can be fully understood from the following detailed description and preferred embodiment with reference to the accompanying drawings, in which:

FIG. 1 is a perspective view showing a connector assembly, in a detached condition, according to a first embodiment of the present invention;

FIG. 2 is a side elevational view, partially broken, of the connector assembly of the first embodiment of the present invention;

FIG. 3 is a perspective view showing a connector assembly, in a detached condition, comprising a slidable power switch constructed in accordance with a second embodiment of the present invention; and

FIG. 4 is a side elevational view, partially broken, of the connector assembly of the second embodiment of the present invention.

### DETAILED DESCRIPTION OF THE PREFERRED EMBODIMENTS

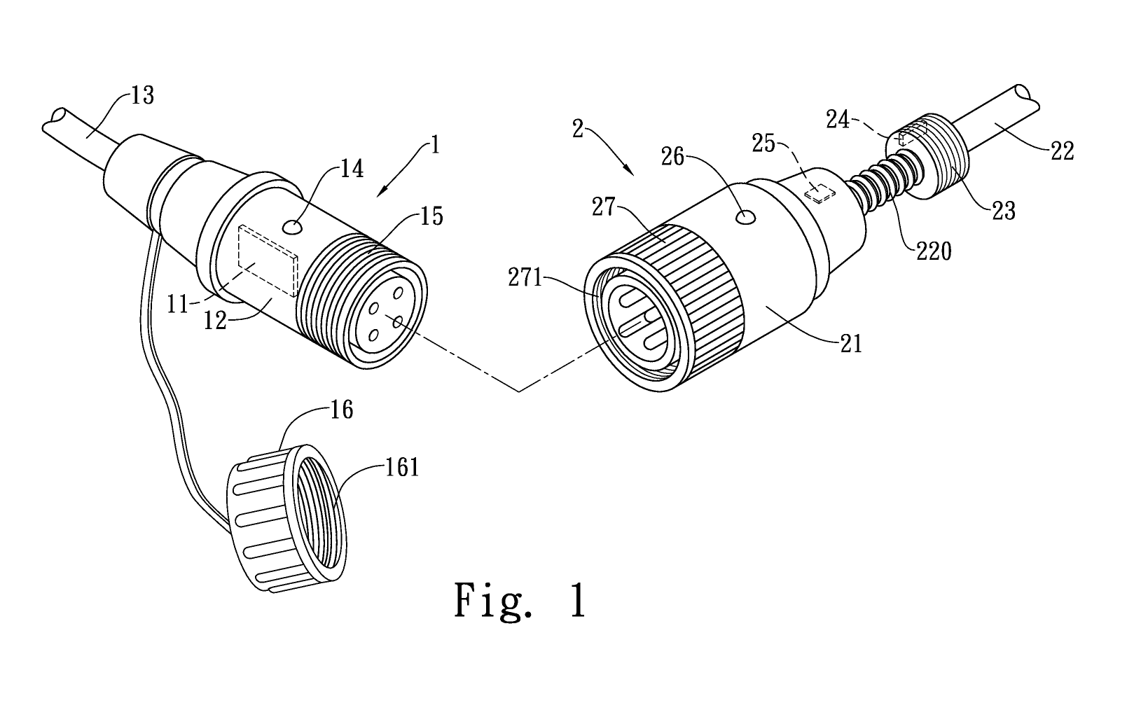

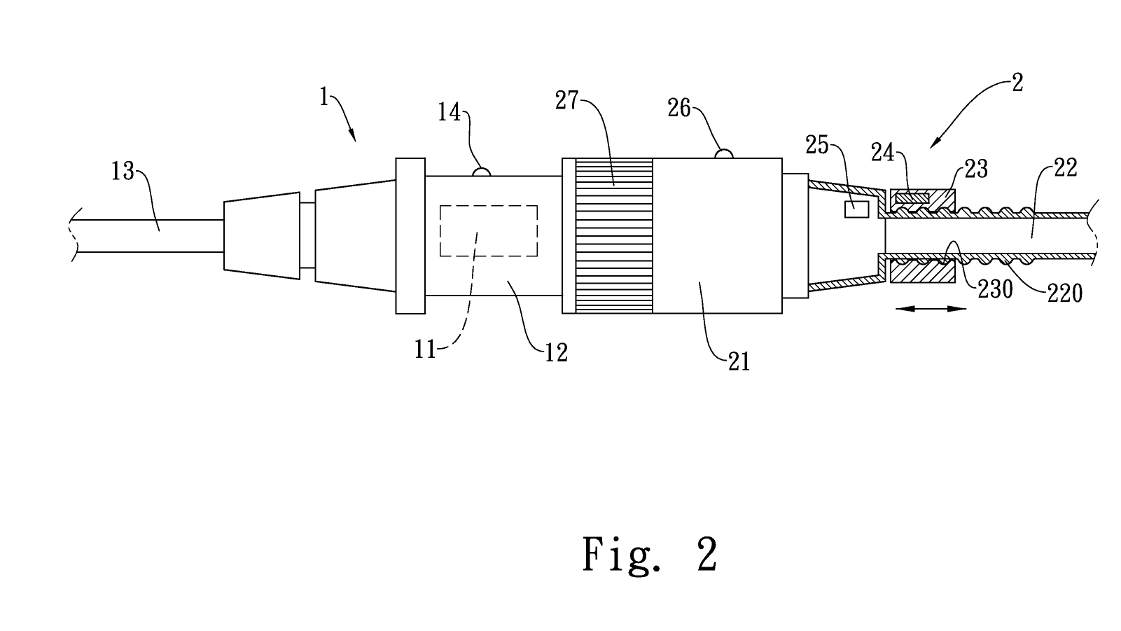

With reference to the drawings and in particular to FIGS. 1 and 2, which shows, respectively, a perspective view and a side elevational view, partially broken, of a connector assembly constructed in accordance with a first embodiment of the present invention, the present invention provides a connector assembly that is composed of a socket connector 1 and a plug connector 2. The socket connector 1 comprises a circuit board received therein. The circuit board comprises a transformer circuit 11, which provides a function of voltage transformation for either direct connection with an electronic product or carrying out a charging operation. The socket connector 1 comprises a socket 12, a closure cap 16, and a transmission cable 13. The socket 12 is for mating and connecting the plug connector 2. The transmission cable 13 has a distal end that is either connected to an electric main inside a house or to be set in connection with a power output, which is put into electrical connection with the plug connector 2 through the transformer circuit 11. The socket connector 1 can alternatively be made in the form of a socket 12 that is directly mounted to for example a wall. The closure cap 16 can be mounted to circumferentially surround an end of the socket connector 1. The closure cap 16 forms therein an internal thread 161, which is matingly engageable with an external thread 15 formed on the end of the socket connector 1 temporarily in case that the socket connector 1 and the plug connector 2 do not threadingly engage each other yet. An insulation substance, such as insulation silicone rubber, is filled in a void space inside the socket connector 1 to ensure humidity resistance and improve security of power transmission of the connector assembly.

The plug connector 2 can be a connector that is provided for charging an electrical bicycle or for charging an electronic product. The plug connector 2 is composed of a plug 21 and a transmission cable 22. The transmission cable 22 has a distal end that is connected to the electrical bicycle or the electronic product. The plug 21 is configured to fit into the socket 12 of the socket connector 1 to carry out the charging operation or to directly transmit electrical power to an electronic product.

The plug connector 2 comprises a slidable power switch 23, which comprises a magnet 24 embedded therein. Further, the plug 21 of the plug connector 2 comprises a magnetic detection element 25 mounted therein for detecting the magnet 24. The magnetic detection element 25 can be for example a Hall IC or other devices providing similar functionality. The slidable power switch 23 is slidably fit over and mounted on the transmission cable 22 and forms in an inside surface thereof a plurality of troughs 230, while the transmission cable 22 forms on an outer surface thereof a plurality of successive ridges 220, whereby the troughs 230 of the slidable power switch 23 are removably engageable with the ridges 220 to selectively set the slidable power switch 23 in a desired position on the transmission cable 22 but allowing the slidable power switch 23 to be moved, in a step-by-step manner, over the ridges 220 of the transmission cable 22 in a direction toward/away from the plug 21. When the slidable power switch 23 is moved toward the plug 21, the magnet 24 is also moved close to the magnetic detection element 25, whereby the magnetic detection element 25 detects a change of magnetic field and thus initiates an activation signal that activates power supply to form a closed circuit. On the other hand, when the slidable power switch 23 is moved away from the magnetic detection element 25, the closed circuit becomes open and the power supply from the socket connector 1 is cut off.

Thus, based on the movement of the slidable power switch 23, the present invention controls the conduction of electrical power through the plug connector 2, whereby there is no need for a user to remove the plug connector 2 from the socket connector 1, making the operation easy and convenient. Further, the plug connector 2 may further comprise an ON/OFF indicator 26, which may comprise a light-emitting diode (LED), whereby when power is set on, the ON/OFF indicator 26 lights, otherwise the indicator is shut down. Similarly, the socket connector 1 is also provided with a power indicator 14, which comprises an LED, whereby when the plug connector 2 and the plug connector 2 mate and engage each other, the indicator lights otherwise sets off.

In addition, the plug connector 2 is provided, at a front end thereof, with a rotatable water-tight collar 27, which has an inside surface forming an internal thread 271 engageable with the external thread 15 of the socket connector 1, whereby when the plug connector 2 mates the socket connector 1, the water-tight collar 27 can be rotated to threadingly engage the external thread 15 of the socket connector 1, realizing a water tight engagement therebetween to suit the needs of outdoor use or a water-proof application.

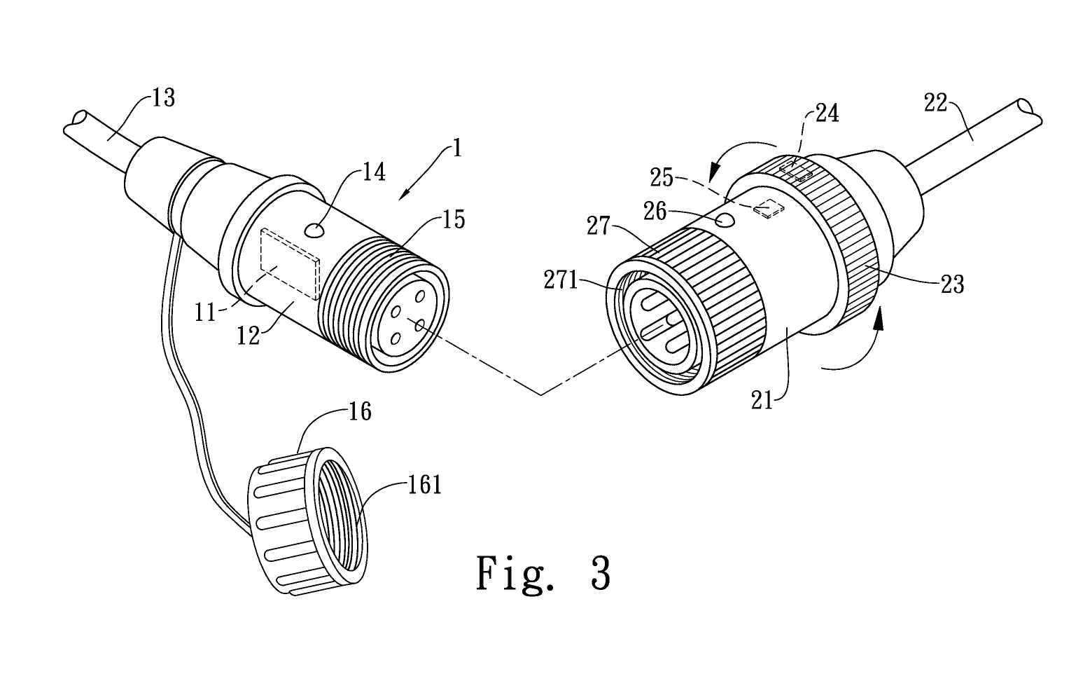

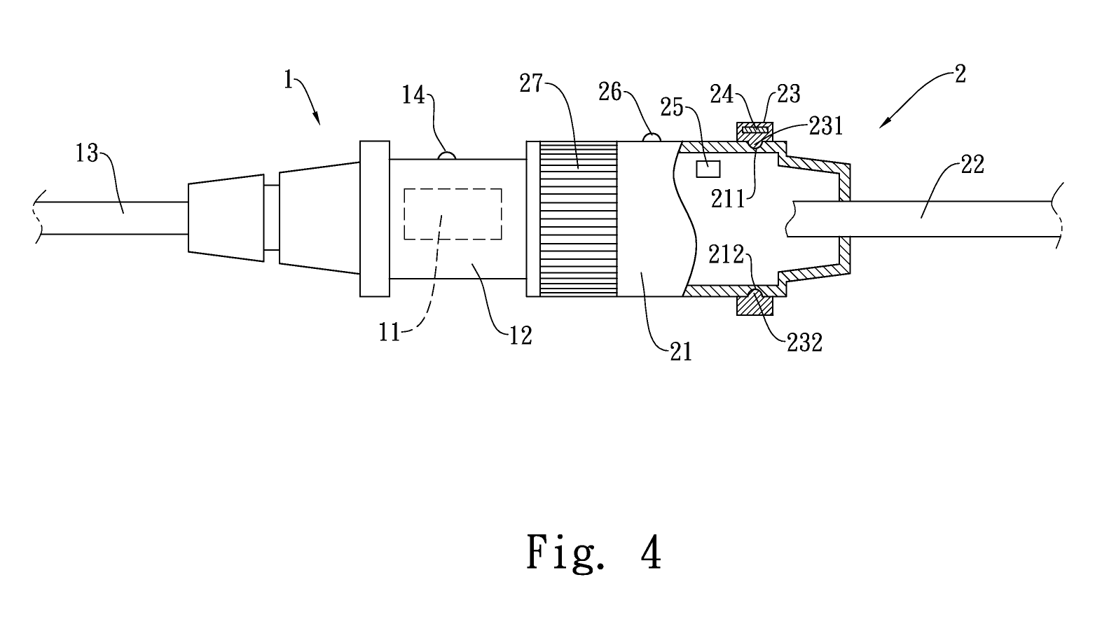

Referring to FIGS. 3 and 4, which show, respectively, a perspective view and a side elevational view, partially broken of a connector assembly comprising a slidable power switch according to a second embodiment of the present invention, the connector assembly of the second embodiment comprises a plug connector 2 carrying thereon a slidable power switch 23 that is constructed as a rotatable ring circumferentially surrounding the plug 21. The ring of the slidable power switch has an inside surface forming a first boss 231 and a second boss 232, which is preferably opposite to each other by angularly spaced by 180 degrees. On the other hand, the plug 21 has an outer surface forming a first dimple 211 and a second dimple 212, which respectively correspond to and are engageable with the bosses, so as to angularly position the slidable power switch 23 with respect to the plug. The slidable power switch 23 comprises a magnet 24 that is located close to the first boss 231, while the plug comprises a magnetic detection element 25 that is located close to the first dimple 211. When the slidable power switch 23 is rotated to have the first boss 231 fit into the first dimple 211, the magnet 24 is set close to the magnetic detection element 25 and the magnetic detection element 25 generates a signal to activate the power supply to form a closed circuit. When the slidable power switch 23 is rotated to have the first boss 231 fit into the second dimple 212, the magnet 24 moves away from the magnetic detection element 25 and the closed circuit is open and the power supply is shut down.

The number of the dimples formed in the plug 21 and that of the bosses formed on the slidable power switch 23 are not limited to two, but it is apparent that there must be at least one of such dimples and at least one of such bosses. Further, instead of forming dimples, the plug 21 may be constructed to form bosses therein, while the slidable power switch 23 forms dimples to replace the bosses. In this way, conduction of electrical power through the connector assembly can be selectively realized through rotation of the slidable power switch and there is no need to unplug and/or re-plug the plug connector, making the operation easy and convenient.

What is claimed is:

1. A connector assembly, comprising:
a socket connector, which comprises a socket, a closure cap, and a transmission cable, the socket connector comprising a transformer circuit arranged therein; and
a plug connector, which is mateable with the socket connector and comprises a plug and a transmission cable, the plug connector comprising a slidable power switch slidably mounted thereon, the slidable power switch comprising a magnet having a magnetic field detectable by a magnetic detection element mounted in the plug, whereby when the slidable power switch changes position to bring the magnet close to the magnetic detection element, a closed circuit is formed and power supply is activated and when the magnet is moved away from the magnetic detection element, the circuit is open and power supply is cut off.

2. The connector assembly according to claim 1, wherein the slidable power switch is movably mounted on the transmission cable of the plug connector, the slidable power switch having an inside surface forming at least one trough, the transmission cable having an outside surface forming a plurality of successive ridges, the trough of the slidable power switch being movably engageable with the ridges.

3. The connector assembly according to claim 1, wherein the slidable power switch comprises a ring that is rotatably mounted around the plug, the ring having an inside surface forming at least one boss, the plug having an outside surface forming at least dimple that is engageable with the boss.

4. The connector assembly according to claim 1, wherein the magnet is embedded in the slidable power switch.

5. The connector assembly according to claim 1, wherein the magnetic detection element comprises a Hall IC.

6. The connector assembly according to claim 1, wherein the plug connector has a front end carrying a rotatable water-tight collar, which has an inside surface forming an internal thread, the socket connector having an outside surface forming an external thread, the water-tight collar being rotatable to threadingly engage the external thread of the socket connector.

7. The connector assembly according to claim 1, wherein the plug connector comprises an ON/OFF indicator.

8. The connector assembly according to claim 1, wherein the socket connector comprises a power indicator.

9. The connector assembly according to claim 1, wherein the socket connector comprises a socket and a transmission cable.

10. The connector assembly according to claim 1, wherein the socket connector comprises a socket that is adapted to be mounted to a wall.

11. The connector assembly according to claim 1, wherein the closure cap is arranged to circumferentially surround an end of the socket connector, the closure cap forming an internal thread for threadingly engaging the socket connector.

12. The connector assembly according to claim 1, wherein the socket connector forms therein a void space for the circuit that is filled with insulation silicone rubber.
